(19) United States
(12) Patent Application Publication
(10) Pub. No.: US 2025/0221462 A1
(43) Pub. Date: Jul. 10, 2025

(54) ATOMIZER AND ELECTRONIC ATOMIZATION DEVICE

(71) Applicant: VERDEWELL INTERNATIONAL HOLDINGS LIMITED, George Town (KY)

(72) Inventors: Zhixiao LUO, Shenzhen (CN); Ju XIE, Shenzhen (CN); Xiaojun ZHONG, Shenzhen (CN)

(21) Appl. No.: 19/010,878

(22) Filed: Jan. 6, 2025

(30) Foreign Application Priority Data
Jan. 8, 2024 (CN) 202410029856.5

(51) Int. Cl. A24F 40/48; A24F 40/10; A24F 40/42; A24F 40/46; H05B 3/28

(52) U.S. Cl. CPC A24F 40/48; A24F 40/10; A24F 40/42; A24F 40/46; H05B 3/28

(57) ABSTRACT

An atomizer includes: a liquid storage main body, a liquid storage cavity and an aerosol outlet channel being formed in the liquid storage main body; a heating base arranged in the liquid storage main body in an axial direction; and an atomization assembly mounted at the heating base, an atomization cavity communicated to the aerosol outlet channel being formed between the atomization assembly and the heating base, the atomization assembly including an atomization surface communicated to the aerosol outlet channel in an aerosol guiding manner. The atomization surface and a longitudinal axis of the atomizer are parallel to each other or form an acute angle. An air inlet channel for communicating the atomization cavity to external atmosphere is formed on the liquid storage main body and/or the heating base. The air inlet channel is at least partially orthogonal to or forms an angle with the atomization surface.

### CROSS-REFERENCE TO PRIOR APPLICATION

Priority is claimed to Chinese Patent Application No. 202410029856.5, filed on Jan. 8, 2024, the entire disclosure of which is hereby incorporated by reference herein.

### FIELD

The present invention relates to the field of atomization technologies, and more specifically, to an atomizer and an electronic atomization device.

### BACKGROUND

An electronic atomization device generally includes an atomizer and a power supply device. The power supply device is configured to supply power to the atomizer. The atomizer is configured to: store an aerosol-forming material and atomize the aerosol-forming material after the atomizer is powered on.

In most existing electronic atomization devices, atomization surfaces of heating elements face downwards, and aerial fog usually needs to make two to three large turns to be gathered at an aerosol outlet channel. This causes loss of a large amount of aerial fog and large particulate aerosols at corner positions.

### SUMMARY

In an embodiment, the present invention provides an atomizer, comprising: a liquid storage main body, a liquid storage cavity and an aerosol outlet channel being formed in the liquid storage main body; a heating base arranged in the liquid storage main body in an axial direction; and an atomization assembly mounted at the heating base, an atomization cavity communicated to the aerosol outlet channel being formed between the atomization assembly and the heating base, the atomization assembly comprising an atomization surface communicated to the aerosol outlet channel in an aerosol guiding manner, wherein the atomization surface and a longitudinal axis of the atomizer are parallel to each other or form an acute angle, wherein an air inlet channel for communicating the atomization cavity to external atmosphere is formed on the liquid storage main body and/or the heating base, and wherein the air inlet channel is at least partially orthogonal to or forms an angle with the atomization surface.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic three-dimensional structural view of an electronic atomization device in some implementations of the present invention;

FIG. 2 is a schematic three-dimensional structural view of an atomizer in FIG. 1;

FIG. 3 is a schematic longitudinal sectional structural view of the atomizer shown in FIG. 2;

FIG. 4 is a schematic longitudinal sectional structural view of the atomizer shown in FIG. 2 in another direction;

FIG. 5 is a schematic exploded structural view of the atomizer shown in FIG. 2;

FIG. 6 is a schematic longitudinal sectional structural view of an atomization main body in FIG. 5;

FIG. 7 is a schematic exploded structural view of the atomization main body in FIG. 6;

FIG. 8 is a schematic exploded structural view of an atomization assembly in FIG. 7;

FIG. 9 is a schematic exploded structural view of an atomization base assembly in FIG. 7;

FIG. 10 is a three-dimensional schematic structural diagram of a heating base in FIG. 9;

FIG. 11 is a schematic diagram of an airflow flowing path in some change embodiments of the present invention;

FIG. 12 is a schematic diagram of an airflow flowing path in some other change embodiments of the present invention;

FIG. 13 is a schematic longitudinal sectional structural view of an atomizer in some change embodiments of the present invention; and

FIG. 14 is a schematic longitudinal sectional structural view of an atomizer in some other change embodiments of the present invention.

### DETAILED DESCRIPTION

In an embodiment, the present invention provides an improved atomizer and an electronic atomization device having the atomizer for the above shortcomings in the existing technology.

In an embodiment, the present invention provides an atomizer, including:
a liquid storage main body, where a liquid storage cavity and an aerosol outlet channel are formed in the liquid storage main body;
a heating base, arranged in the liquid storage main body in an axial direction; and
an atomization assembly, mounted at the heating base, where an atomization cavity communicated to the aerosol outlet channel is formed between the atomization assembly and the heating base.

The atomization assembly includes an atomization surface communicated to the aerosol outlet channel in an aerosol guiding manner; the atomization surface and a longitudinal axis of the atomizer are parallel to each other or form an angle; and the angle is an acute angle.

An air inlet channel for communicating the atomization cavity to external atmosphere is formed on the liquid storage main body and/or the heating base; and the air inlet channel is at least partially orthogonal to or forms an angle with the atomization surface.

In some embodiments, the air inlet channel includes a main air inlet path arranged on the outer surface of the heating base and an air outlet provided in the side wall of the heating base in a penetrating manner; and the axis of the air outlet is orthogonal to or forms an acute angle with the atomization surface.

In some embodiments, the air inlet channel includes an air inlet hole provided in the side wall of the liquid storage main body in a penetrating manner and an air outlet provided in the side wall of the heating base in a penetrating manner; and the axis of the entire air inlet channel is orthogonal to or forms an acute angle with the atomization surface.

In some embodiments, the air inlet channel is provided with an air outlet in the end communicated to the atomization cavity; the air outlet is provided in the side wall of the heating base in a penetrating manner; and the air outlet and the atomization surface are respectively located on two opposite sides of the atomization cavity.

In some embodiments, the inner wall surface of the heating base inwards protrudes to form a surrounding rib that surrounds the air outlet.

In some embodiments, an axial direction of the surrounding rib is perpendicular to the atomization surface or forms an acute angle with the atomization surface.

In some embodiments, the heating base includes a main pipe section and a lower pipe section downwards extending from the lower end surface of the main pipe section.

In some embodiments, a cavity provided with an opening in the circumferential side is formed in the main pipe section; the atomization assembly is embedded into the opening of the cavity.

The air inlet channel includes a first air inlet section arranged on the outer wall surface of the main pipe section and a second air inlet section arranged on the outer wall surface of the lower pipe section; and a chamfer is formed at a connection of the first air inlet section and the second air inlet section.

In some embodiments, the atomization assembly includes a heating element and a fixing base; the heating element is embedded into one side of the fixing base; a liquid down-flow channel for communicating the liquid storage cavity to the heating element is formed in the fixing base; and the air inlet channel and the liquid down-flow channel are respectively located on the two opposite sides of the heating element.

In some embodiments, the heating element is plate-like.

The present invention further provides an electronic atomization device, including the above atomizer and a power supply device connected to the atomizer in a matched manner.

Implementation of the present invention at least has the following beneficial effects: In the present invention, the atomization surface and the longitudinal axis of the atomizer are parallel to each other or form the acute angle, and the air inlet channel is at least partially orthogonal to or forms an angle with the atomization surface, so that an airflow can flow more smoothly, and the loss of aerial fog is low.

To provide a clearer understanding of the technical features, objectives, and effects of the present invention, specific implementations of the present invention are described in detail with reference to the accompanying drawings. In the following description, numerous specific details are set forth in order to provide a thorough understanding of the present invention. The present invention may, however, be embodied in many forms different from that described here. A person skilled in the art can make similar improvements without departing from the connotation of the present invention. Therefore, the present invention is not limited by the specific embodiments disclosed below.

In the description of the present invention, it should be understood that orientations or positional relationships indicated by the terms “longitudinal”, “transverse”, “upper”, “lower”, “top”, “bottom”, “inner”, “outer”, and the like are orientations or positional relationships as shown in the drawings or orientations or positional relationships where this invention product is often located during use, and are only for the purpose of facilitating and simplifying the description of the present invention instead of indicating or implying that devices or elements indicated need to have particular orientations, and be constructed and operated in the particular orientations, so that these terms are not construed as limiting the present invention.

In addition, the terms “first” and “second” are used for descriptive purposes only and are not to be construed as indicating or implying relative importance or to implicitly indicate the number of technical features indicated. From this, features defined as “first” and “second” may explicitly or implicitly include at least one feature. In the description of the present disclosure, “plurality” means at least two, for example, two and three, unless explicitly specified otherwise.

In the present invention, unless otherwise explicitly specified and limited, the terms “mount”, “connect”, “connection”, and “fix” should be understood in a broad sense. For example, a connection may be a fixed connection, a detachable connection, or an integral connection; or the connection may be a mechanical connection or an electrical connection; or the connection may be a direct connection, an indirect connection through an intermediate medium, an internal communication of two elements, or interaction between two elements, unless expressly specified otherwise. Persons of ordinary skill in the art may understand the specific meanings of the foregoing terms in the present invention according to specific situations.

In the present invention, unless otherwise explicitly stipulated and restricted, that a first feature is “on” or “below” a second feature may include that the first and second features are in direct contact, or may include that the first and second features are in indirect contact using an intermediate. In addition, that the first feature is “above” the second feature may indicate that the first feature is directly above or obliquely above the second feature, or may merely indicate that the horizontal position of the first feature is higher than that of the second feature. That the first feature is “below” the second feature may be that the first feature is right below the second feature or at an inclined bottom of the second feature, or may merely indicate that the horizontal position of the first feature is lower than that of the second feature.

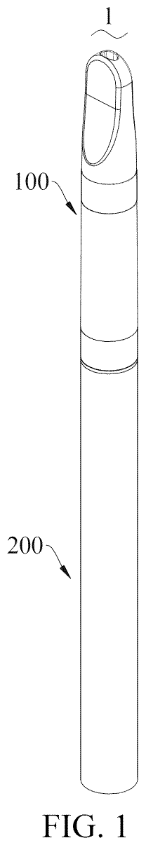

FIG. 1 shows an electronic atomization device 1 in some embodiments of the present invention. The electronic atomization device 1 includes an atomizer 100 and a power supply device 200 connected to the atomizer 100 in a matched manner. The power supply device 200 usually includes a battery for supplying power to the atomizer 100 and a control circuit for controlling the atomizer 100 to generate heat.

The atomizer 100 is configured to: accommodate an aerosol-forming material, and heat and atomize the aerosol-forming material after the atomizer 100 is powered on, so as to form an aerosol. In some embodiments, both the atomizer 100 and the power supply device 200 can be approximately cylindrical, and can be mechanically and electrically connected to each other in an axial direction. Further, the atomizer 100 and the power supply device 200 can be connected in a detachable manner such as magnetic suction connection, threaded connection, and snap connection. It can be understood that in other embodiments, the atomizer 100 and the power supply device 200 can also be connected together in a non-detachable manner. In addition, the cross section of the atomizer 100 and/or the cross section of the power supply device 200 may be, but not limited to, circular, elliptical, runway-shaped, rectangular, or in other shapes.

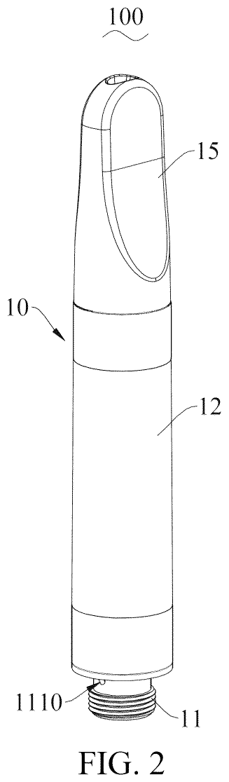

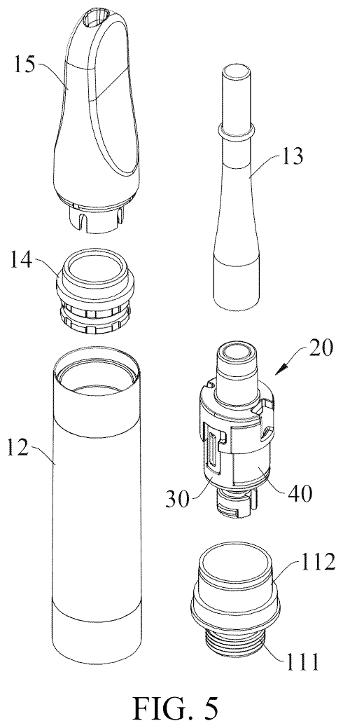

As shown in FIG. 2 to FIG. 5, the atomizer 100 may include a liquid storage main body 10 and an atomization main body 20 accommodated in the liquid storage main body 10. A liquid storage cavity 120 for accommodating an aerosol-forming material and an aerosol outlet channel 135 that is isolated from the liquid storage cavity 120 and is configured to output an aerosol is formed in the liquid storage main body 10. An inhalation opening 151 communicated to the aerosol outlet channel 135 is provided in one end of the liquid storage main body 10 (the upper end in the figure). The atomization main body 20 includes a heating element 41 that is communicated to the liquid storage cavity 120 in a liquid guiding manner and is communicated to the aerosol outlet channel 135 in an aerosol guiding manner. When a user inhales at the inhalation opening 151, the heating element 41 atomizes an aerosol-forming material to form an aerosol. The aerosol then reaches the inhalation opening 151 through the aerosol outlet channel 135 for being inhaled by the user.

In some embodiments, the liquid storage main body 10 may include a liquid storage shell 12, a base 11 and a mouthpiece 15 which are respectively arranged at two ends of the liquid storage shell 12, and an aerosol guide pipe 13 arranged in the liquid storage shell 12. The liquid storage shell 12 can be in a shape of a circular tube with openings in the two ends, but is not limited to the circular-tube shape. The aerosol guide pipe 13 can be arranged in the liquid storage shell 12 in an axial direction and can be, but not limited to, coaxial with the liquid storage shell 12. An exporting channel 130 is formed in the aerosol guide pipe 13, and the circular-ring-shaped liquid storage cavity 120 is formed between the outer wall surface of the aerosol guide pipe 13 and the inner wall surface of the liquid storage shell 12.

The mouthpiece 15 is arranged at an upper end of the liquid storage shell 12 and covers an opening in the upper end of the liquid storage shell 12. An inhalation channel 150 is formed in a penetrating manner in the mouthpiece 15 in the axial direction, and the inhalation channel 150 is communicated to the exporting channel 130 to form the aerosol outlet channel 135. The upper end of the aerosol guide pipe 13 can be embedded in the inhalation channel 150 and in sealed fit with the wall surface of the inhalation channel 150.

In some embodiments, the liquid storage main body 10 may further include a seal member 14 arranged at the upper end of the liquid storage shell 12. The seal member 14 can be made of an elastic material such as silica gel. The seal member 14 is at least partially hermetically arranged between the inner wall surface of the liquid storage shell 12 and the outer wall surface of the aerosol guide pipe 13, to seal the upper end of the liquid storage cavity 120 and ensure the air tightness between the liquid storage cavity 120 and the aerosol outlet channel 135.

The base 11 is arranged at the lower end of the liquid storage shell 12 and covers the opening in the lower end of the liquid storage shell 12. The base 11 may be in a shape of a hollow cylinder, and may include a main body portion 112 and a screwing portion 111 extending downward from the lower end surface of the main body portion 112. The main body portion 112 is at least partially embedded in the liquid storage shell 12 and can be sealed and fixed to the liquid storage shell 12 through interference fit and the like. The inner diameter and outer diameter of the main body portion 112 are respectively greater than those of the screwing portion 111. An external thread for achieving threaded connection with the power supply device 200 may be arranged on the outer wall surface of the screwing portion 111. At least one air inlet hole 1110 for allowing external air to enter may be further provided in the side wall of the screwing portion 111. Preferably, at least two air inlet holes 1110 may be distributed in a uniformly spaced manner in the side wall of the screwing portion 111 in a circumferential direction.

In some embodiments, the base 11 may be made of a conductive material such as metal, and one electrode of the heating element 41 may be electrically connected to the power supply device 200 through the base 11. Certainly, in some other embodiments, the base 11 may be made of an insulating material.

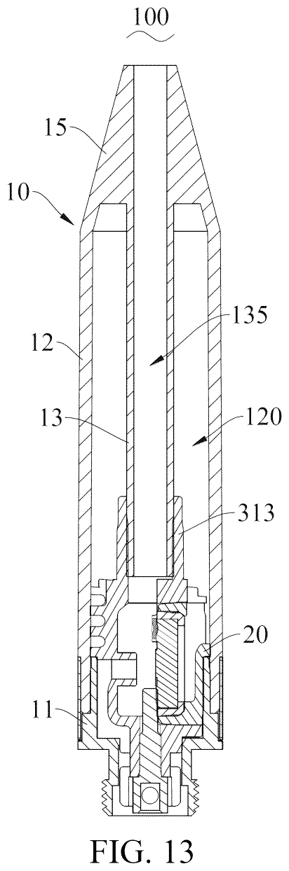

It can be understood that in other embodiments, the liquid storage main body 10 is not limited to the specific structure mentioned above. For example, in the embodiment shown in FIG. 13, the liquid storage shell 12, the mouthpiece 15, and the aerosol guide pipe 13 are integrally formed, thereby eliminating the step of assembling the mouthpiece 15 and the seal member 14 and simplifying the assembling process. Certainly, in some other embodiments, the liquid storage shell 12 and the mouthpiece 15 may be integrally formed, and the aerosol guide pipe 13 is arranged independently. Or, the liquid storage shell 12 and the aerosol guide pipe 13 may be integrally formed, and the mouthpiece 15 is arranged independently.

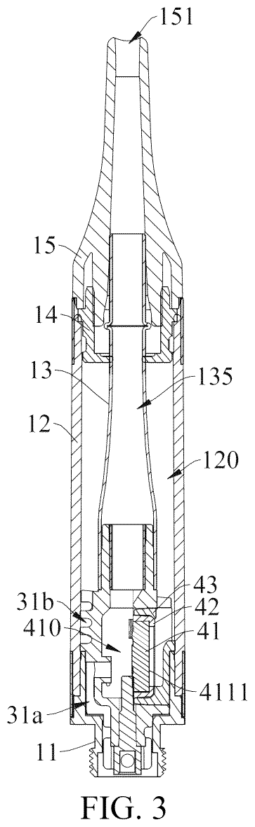

As shown in FIG. 3 to FIG. 6, the atomization main body 20 is arranged at one end of the liquid storage main body 10 away from the inhalation opening 151. The atomization main body 20 can be approximately in a shape of a stepped cylinder and includes an atomization base assembly 30 and an atomization assembly 40 mounted on the atomization base assembly 30. An atomization cavity 410 is formed between the atomization assembly 40 and the atomization base assembly 30. An air inlet channel 31a communicated to external air is provided in the atomization base assembly 30 and/or the liquid storage main body 10. The atomization cavity 410 is respectively communicated to the air inlet channel 31a and the exporting channel 130.

In some embodiments, a vent channel 31b that communicates the liquid storage cavity 120 to the external atmosphere may be further formed on the atomization base assembly 30 and/or the liquid storage main body 10. The vent channel 31b can timely supplement air in the liquid storage cavity 120, thus maintaining atmospheric pressure balance and solving the problem that liquid cannot flow down stably due to an excessive negative pressure inside the liquid storage cavity 120.

The atomization assembly 40 includes a heating element 41. The heating element 41 includes a liquid guiding substrate 411 and a heating member 412 arranged on the liquid guiding substrate 411. Specifically, the heating member 412 may be attached to the outer surface of the liquid guiding substrate 411, or the heating member 412 may be partially or entirely embedded into the outer surface.

The liquid guiding substrate 411 has a liquid absorbing surface 4111 and an atomization surface 4112. The liquid absorbing surface 4111 is communicated to the liquid storage cavity 120 in a liquid guiding manner. The liquid guiding substrate 411 absorbs an aerosol-forming material from the liquid storage cavity 120 through the liquid absorbing surface 4111 and guides the aerosol-forming material to the atomization surface 4112. The atomization surface 4112 defines a partial boundary surface of the atomization cavity 410. The heating member 412 is arranged on the atomization surface 4112 to heat and atomize, after being powered on for heating, the aerosol-forming material absorbed by the liquid guiding substrate 411.

In some embodiments, the liquid guiding substrate 411 may be made of porous ceramic to form a large number of micro pores in the liquid guiding substrate 411 and have a porosity. Under the capillary action of the micro pores, the liquid guiding substrate 411 can absorb and temporarily store the aerosol-forming material. The liquid guiding substrate 411 can be plate-like. Namely, a thickness of the liquid guiding substrate 411 is less than its length and width. The atomization surface 4112 and the liquid absorbing surface 4111 can be two surfaces of the liquid guiding substrate 411 arranged oppositely in a thickness direction, so that both the atomization surface 4112 and the liquid absorbing surface 4111 have large areas, which is conducive to improving the liquid absorbing efficiency and the atomization efficiency. Certainly, in some other embodiments, a shape and material of the liquid guiding substrate 411 are not limited. For example, the liquid guiding substrate 411 may alternatively be made of natural cotton, a high molecular material, and the like.

Both the atomization surface 4112 and the liquid absorbing surface 4111 are planes arranged in a vertical direction, and the atomization surface 4112 and the liquid absorbing surface 4111 are parallel to the axial direction of the atomizer 100, the axial direction of the liquid storage cavity 120, and the axial direction of the aerosol outlet channel 135. The atomization surface 4112 is parallel to the axial direction of the aerosol outlet channel 135, which is convenient for an airflow to flow through the atomization surface 4112 and bring away the aerosol generated after atomization.

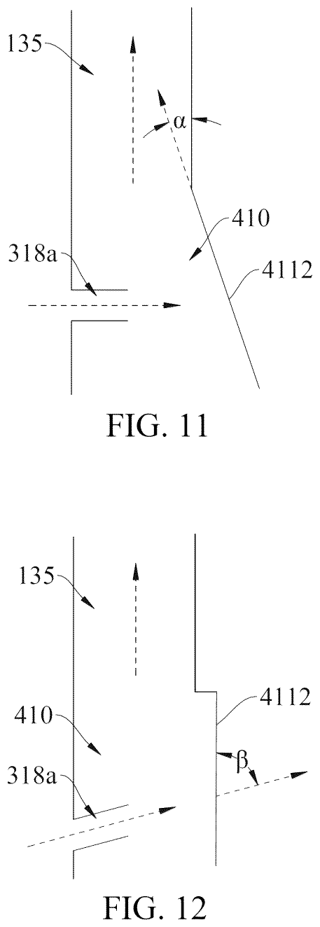

In some other embodiments, as shown in FIG. 11, the atomization surface 4112 may alternatively be slantways arranged in an angle α with the axial direction of the atomizer 100, and thus, the atomization surface 4112 is arranged in the angle α with the axial direction of the aerosol outlet channel 135. Preferably, the angle α is an acute angle, which makes a deflection angle of the airflow in the process of entering the aerosol outlet channel 135 from the atomization cavity 410 less than 90°, so that the airflow flows more smoothly, and the loss of aerial fog is low.

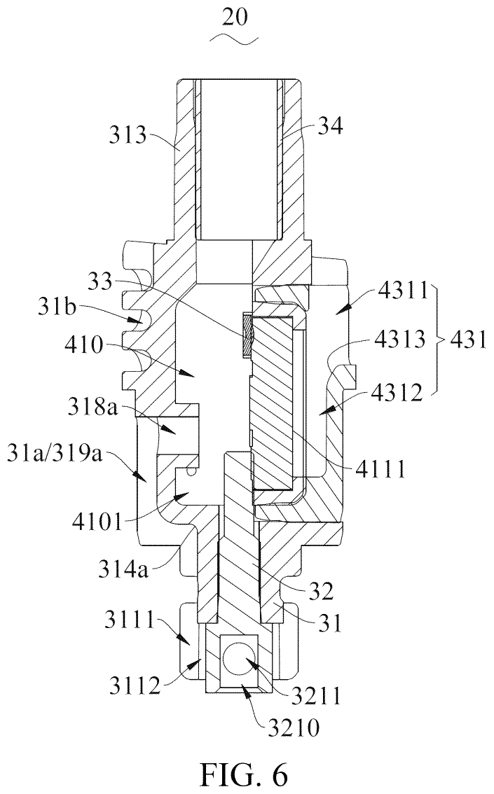

As shown in FIG. 6 and FIG. 12, the axial direction of at least part of the air inlet channel 31a is orthogonal to or forms an angle with the atomization surface 4112. The angle is preferably an acute angle. An air inlet direction of the air inlet channel 31a is towards the atomization surface 4112, which facilitates the aerial fog to be brought out. Specifically, the air inlet channel 31a includes an air outlet section 318a that is directly communicated to the atomization cavity 410. In this embodiment shown in FIG. 6, the axial direction of the air outlet section 318a is perpendicular to the atomization surface 4112, which facilitates the aerial fog to be brought out and can prevent blockage and liquid leakage of the air outlet section 318a compared with the way of feeding air from the bottom. In this embodiment shown in FIG. 12, the axial direction of the air outlet section 318a is arranged in an angle β with the atomization surface 4112. The angle β is an acute angle, so that the deflection angle of the airflow in the process of entering the atomization cavity 250 from the air outlet section 318a is less than 90°, making the airflow flow more smoothly, reducing the loss of aerial fog, and preventing blockage and liquid leakage of the air outlet section 318a.

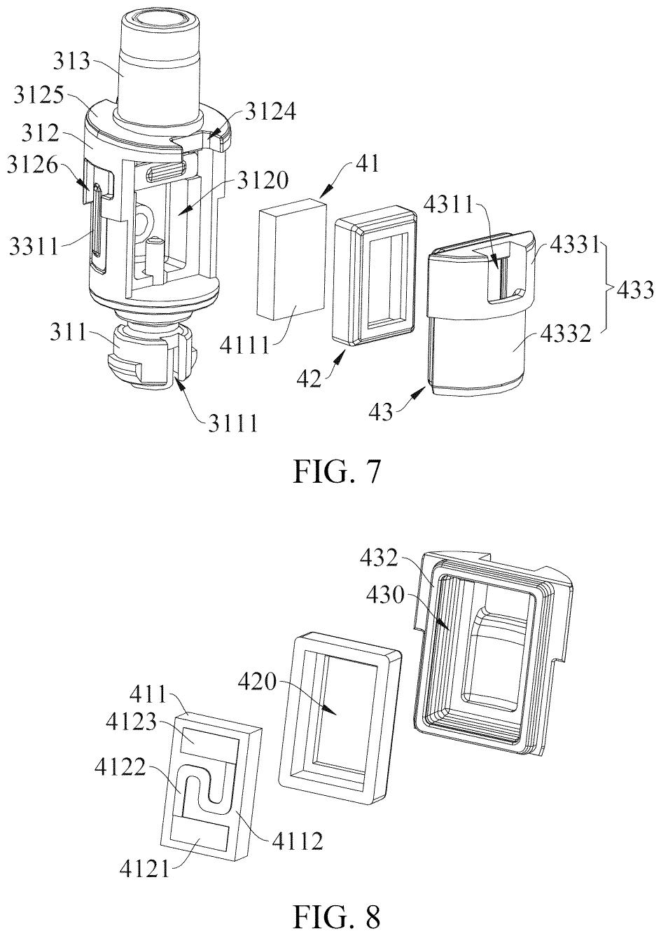

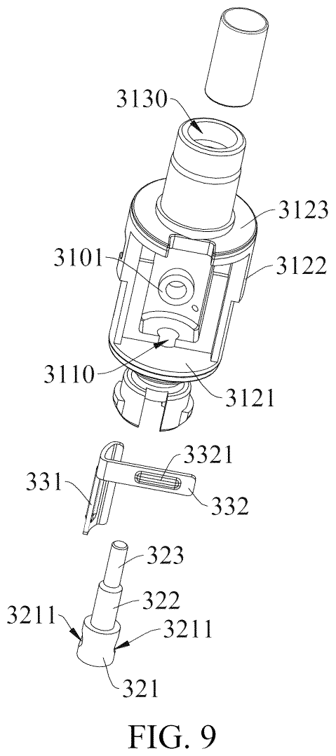

As shown in FIG. 3 to FIG. 9, the specific structure of the heating member 412 is not limited. For example, it may be a resistive heating film, a metal sheet, a metal mesh, or the like. In this embodiment, the heating member 412 is a heating film, which is beneficial for uniformly heating the surface of the heating element 41. The atomization surface 4112 is a plane, which facilitates the formation of a uniform heating film. The heating member 412 may include a heating trajectory 4122, and a first electrode portion 4121 and a second electrode portion 4123 which are respectively connected to the two ends of the heating trajectory 4122. The heating trajectory 4122 is mainly configured to generate heat after being powered on, and its specific shape is not limited. For example, the heating trajectory 4122 may be S-shaped or spiral-shaped. The first electrode portion 4121 and the second electrode portion 4123 are configured to electrically connect the heating trajectory 4122 with the power supply device 200, and can be respectively located at the lower end and the upper end of the heating trajectory 4122. Certainly, in some other embodiments, the positions of the first electrode portion 4121 and the second electrode portion 4123 are not limited either. For example, the first electrode portion 4121 and the second electrode portion 4123 may alternatively be respectively located at the two transverse ends of the heating trajectory 4122, or may be both located at the lower end of the heating trajectory 4122.

In some embodiments, the atomization assembly 40 may further include a seal gasket 42 sleeving the heating element 41.

The seal gasket 42 can be made of an elastic material such as silica gel, which can prevent liquid leakage on the one hand, and protect the heating element 41 from being crushed during mounting on the other hand. The seal gasket 42 can be approximately rectangularly ringlike and wrapped around the circumference of the heating element 41 to seal the circumference of the heating element 41. A liquid inlet 420 for communicating the liquid storage cavity 120 with the liquid absorbing surface 4111 is provided in the seal gasket 42 in a penetrating manner. The liquid inlet 420 can expose the majority of the surface of the liquid absorbing surface 4111, which is beneficial for improving the liquid absorbing efficiency of the heating element 41.

In some embodiments, the atomization assembly 40 may further include a fixing base 43. The heating element 41 is accommodated on one side of the fixing base 43, and the seal gasket 42 is hermetically arranged between the heating element 41 and the fixing base 43. The fixing base 43 may be made of a hard material such as plastic (e.g. polyformaldehyde (POM)). Certainly, in other embodiments, the fixing base 43 may alternatively be made of an elastic material such as silica gel. In some other embodiments, the fixing base 43 and the seal gasket 42 can be integrally formed.

An accommodating cavity 430 is provided in one side surface (the inner side surface 432 described below) of the fixing base 43. Both the heating element 41 and the seal gasket 42 are mounted in the accommodating cavity 430. The heating element 41, the seal gasket 42, and the fixing base 43 can be in sealed fit through interference fit and the like, to reduce liquid leakage. Preferably, the inner side surface 432 is a plane, which facilitates the sealed fit with a heating base 31.

The other side surface (hereinafter referred to as the outer side surface 433) of the fixing base 43 is in sealed fit with the inner wall surface of the liquid storage shell 12 and/or the inner wall surface of the base 11, to prevent liquid leakage. Specifically, in this embodiment, the lower part of the fixing base 43 is accommodated in the main body portion 112 of the base 11. A lower outer side surface 4332 of the lower part of the outer side surface 433 is an arc surface and is in sealed fit with the inner wall surface of the main body portion 112. An upper outer side surface 4331 of the upper part of the outer side surface 433 is an arc surface and is in sealed fit with the inner wall surface of the liquid storage shell 12.

A liquid down-flow channel 431 for communicating the liquid storage cavity 120 with the liquid inlet 420 is further formed on the fixing base 43. The liquid down-flow channel 431 and the atomization cavity 410 are respectively located on two transversely opposite sides of the heating element 41. The size of the liquid down-flow channel 431 can be adjusted according to the size of the heating element 41 or a liquid supply demand. In some embodiments, a chamfer 4313 (including a rounded corner or a bevel angle) may be further arranged in the liquid down-flow channel 431 to make the aerosol-forming material in the liquid down-flow channel 431 flow more smoothly, so that the aerosol-forming material is guided to the liquid absorbing surface 4111 to ensure that liquid flows down.

In some embodiments, the liquid down-flow channel 431 includes a side liquid down-flow channel 4311 and an inner liquid down-flow channel 4312 which are communicated to each other in sequence from top to bottom. A chamfer 4313 is formed at a connection of the side liquid down-flow channel 4311 and the inner liquid down-flow channel 4312. The inner liquid down-flow channel 4312 is formed on the inner side of the fixing base 43. Specifically, the accommodating cavity 430 is arranged on the inner side surface 432 of the fixing base 43. When the heating element 41, the seal gasket 42, and the fixing base 43 are assembled together, the heating element 41 and the seal gasket 42 cover an opening of the accommodating cavity 430, and the inner liquid down-flow channel 4312 is formed between the liquid absorbing surface 4111 of the heating element 41 and the accommodating cavity 430. The liquid down-flow channel 4311 is formed on the outer side of the upper part of the fixing base 43 and can be formed by penetrating downwards and inwards from the top of the upper outer side surface 4331 of the fixing base 43. After the atomization assembly 40 is mounted in the liquid storage shell 12, the inner wall surface of the liquid storage shell 12 is in sealed fit with the upper outer side surface 4331, thereby sealing an opening in the outer side of the side liquid down-flow channel 4311 and communicating an opening in the upper side of the side liquid down-flow channel 4311 to the liquid storage cavity 120.

The atomization base assembly 30 may include a heating base 31, and a first electrode 32 and a second electrode 33 which are mounted on the heating base 31. The heating base 31 is accommodated in the lower part of the liquid storage shell 12 in the axial direction and can be, but not limited to, coaxial with the liquid storage shell 12. The heating base 31 has a liquid down-flow plane 3125. The liquid down-flow plane 3125 defines at least part of a bottom boundary of the liquid storage cavity 120. The heating base 31 may be made of a hard material such as plastic (e.g. POM). Certainly, in other embodiments, the heating base 31 may alternatively be made of another other material. The atomization assembly 40 is mounted on the heating base 31, and the atomization cavity 410 is formed between the atomization assembly 40 and the heating base 31. In some embodiments, the atomization assembly 40 is at least partially embedded in the heating base 31. Specifically, the circumferential side of the heating base 31 is opened to form a cavity 3120. The atomization assembly 40 is pressed into an opening of the cavity 3120 and seal the opening of the cavity 3120. Two electrodes of the heating member 412 are electrically connected to the first electrode 32 and the second electrode 33, respectively. The fixing base 43 and the heating base 31 can be fixed and sealed by interference fit and the like.

The heating base 31 has a stepped tubular structure, and may include a lower pipe section 311, a main pipe section 312, and an upper pipe section 313 which are arranged in sequence from bottom to top in the axial direction. The lower pipe section 311 may be arranged in the screwing portion 111 in the axial direction and may be in buckled connection with the screwing portion 111. An electrode hole 3110 that is communicated to the atomization cavity 410 and is configured to allow the first electrode 32 to be inserted is formed in a penetrating manner in the lower pipe section 311 in the axial direction, and an air outlet hole 3130 for communicating the atomization cavity 410 with the exporting channel 130 is formed in a penetrating manner in the upper pipe section 313 in the axial direction.

A liquid collection slot 4101 for storing condensate, an aerosol-forming material flowing into the atomization cavity 410 through the vent channel 31b, and an aerosol-forming material penetrating through the heating element 41 is formed in the lower part of the atomization cavity 410. The outer wall surface of the first electrode 32 and the wall surface of the electrode hole 3110 can be in sealed fit through interference fit and the like, thereby sealing the electrode hole 3110 and avoiding leakage of the aerosol-forming material from the electrode hole 3110. The upper end surface of the electrode hole 3110 and the bottom surface of the liquid collection slot 4101 are located on the same plane, to avoid occupation of a liquid storage space of the liquid collection slot 4101 due to formation of a boss in the electrode hole 3110. Certainly, in some other embodiments, the upper end surface of the electrode hole 3110 may protrude out of or be sunken into the bottom surface of the liquid collection slot 4101.

In a working or placement process of the atomizer 100, the aerosol-forming material may penetrate and flow into the atomization cavity 410 through the heating element 41. In addition, the vent channel 31b may enable the aerosol-forming material to flow into the atomization cavity 410 under the action of a pressure difference. Due to the design of the liquid collection slot 4101, the leaking aerosol-forming material can be well stored. The liquid collection slot 4101 is arranged at the lower part of the atomization cavity 410 and on the side where the heating member 412 is located. When the heating element 41 works, the heating member 412 can recycle and atomize the aerosol-forming material in the liquid collection slot 4101, to avoid waste.

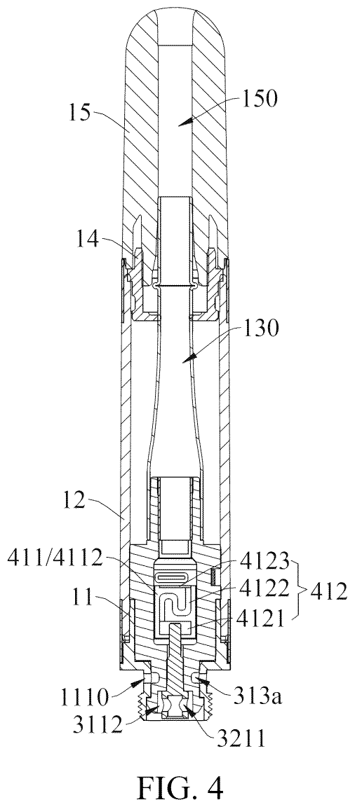

The upper pipe section 313 may be arranged in the aerosol guide pipe 13 or may sleeve the aerosol guide pipe 13. In the embodiment shown in FIG. 4 to FIG. 6, the upper pipe section 313 is embedded into the aerosol guide pipe 13. The outer wall surface of the upper pipe section 313 and the inner wall surface of the aerosol guide pipe 13 can be sealed through interference fit and the like. Further, a tubular support element 34 may be further embedded into the upper pipe section 313. The support element 34 may be made of a metal material such as stainless steel to enhance the structural strength of the upper pipe section 313, to ensure tight connection between the upper pipe section 313 and the aerosol guide pipe 13. In the embodiment shown in FIG. 13, the upper pipe section 313 sleeves the aerosol guide pipe 13.

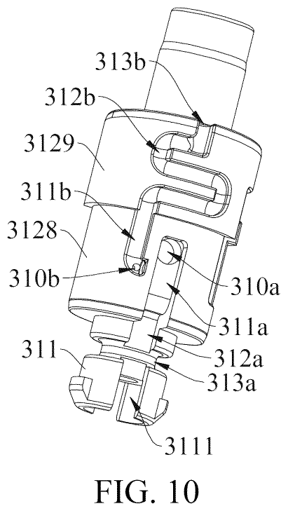

As shown in FIG. 4 to FIG. 10, in some embodiments, the outer diameter of the main pipe section 312 is greater than the outer diameter of the lower pipe section 311 and the outer diameter of the upper pipe section 313. The inner diameter of the main pipe section 312 is greater than the inner diameter of the lower pipe section 311 and the inner diameter of the upper pipe section 313. The atomization assembly 40 is mounted on the circumferential side of the main pipe section 312. Specifically, the main pipe section 312 may include a pipe wall 3122, and a top wall 3123 and a bottom wall 3121 which are respectively arranged at two axial ends of the pipe wall 3122. The lower pipe section 311 integrally downwards extends from the bottom wall 3121, and the upper pipe section 313 integrally upwards extends from the top wall 3123. A liquid down-flow notch 3124 for communicating the liquid storage cavity 120 to the liquid down-flow channel 431 is formed in the top wall 3123 in a penetrating manner.

Specifically, the liquid down-flow notch 3124 may be located at an edge of one side of the top wall 3123 and is correspondingly communicated to the upper end of the side liquid down-flow channel 4311. The pipe wall 3122 is approximately in a shape of C-shaped tube, and the circumferential side of the pipe wall is opened to form the cavity 3120 for mounting the atomization assembly 40. The atomization assembly 40 may be pressed into the main pipe section 312 from an opening of the pipe wall 3122 and covers the opening of the cavity 3120 to form the atomization cavity 410. The upper and lower end surfaces of the atomization assembly 40 may respectively lean against the top wall 3123 and the bottom wall 3121, thereby clamping and fixing the atomization assembly 40. The lower part of the main pipe section 312 may be accommodated in the main body portion 112 of the base 11, and the upper part of the main pipe section 312 is located outside the main body portion 112. Specifically, the main pipe section 312 may include a first branch portion 3128 accommodated in the main body portion 112 and a second branch portion 3129 extending out of the main body portion 112. The outer surface of the first branch portion 3128 and the inner wall surface of the main body portion 112 may be in sealed fit through interference fit and the like. The outer surface of the second branch portion 3129 and the inner wall surface of the liquid storage shell 12 are in sealed fit through interference fit and the like. Certainly, in some other embodiments, the main pipe section 312 may alternatively be completely accommodated in the main body portion 112 or completely located outside the main body portion 112.

The liquid down-flow plane 3125 is formed on the upper end surface of the top wall 3123. The liquid down-flow plane 3125 defines the bottom boundary of the liquid storage cavity 120. In some embodiments, the liquid down-flow plane 3125 is an oblique plane with an inclination angle, and has a slope tilting towards the liquid down-flow notch 3124, so that the aerosol-forming material in the liquid storage cavity 120 can smoothly flow towards the liquid down-flow notch 3124 along the liquid down-flow plane 3125, and the aerosol-forming material can be fully used. Certainly, in some other embodiments, the liquid down-flow plane 3125 may alternatively be a curvilinear structure such as a cambered surface.

The first electrode 32 is electrically connected to the first electrode portion 4121 of the heating member 412, and may be an electrode column. The first electrode 32 is threaded into the lower pipe section 311 in the axial direction. The lower end of the first electrode 32 is electrically connected to the power supply device 200, and the upper end resists against the first electrode portion 4121 for switching on.

In some embodiments, the first electrode 32 may include a first columnar portion 321, a second columnar portion 322, and a third columnar portion 323 which are arranged in sequence from bottom to top. The outer diameters of the first columnar portion 321, the second columnar portion 322, and the third columnar portion 323 may decrease in sequence to facilitate embedding of the first electrode 32 into the electrode hole 3110 from bottom to top. Certainly, in some other embodiments, the outer diameters of the first columnar portion 321, the second columnar portion 322, and the third columnar portion 323 are not limited. For example, the outer diameter of the second columnar portion 322 may alternatively be equal to the outer diameter of the first columnar portion 321 or the outer diameter of the third columnar portion 323.

The third columnar portion 323 extends into the atomization cavity 410 and resists against the first electrode portion 4121 for switching on. The first columnar portion 321 and the second columnar portion 322 are threaded into the lower pipe section 311. The second columnar portion 322 is tightly connected to the electrode hole 3110 of the lower pipe section 311, thereby fixing the first electrode 32 in the heating base 31 and sealing the electrode hole 3110.

In some embodiments, the bottom surface of the first columnar portion 321 may be sunken upwards to form a ventilation hole 3210, and at least one air inlet 3211 is provided in the side wall of the first columnar portion 321 in a penetrating manner. An annular airflow channel 3112 is formed between the outer wall surface of the first columnar portion 321 and the inner wall surface of the lower pipe section 311, and at least one air vent 3111 is provided in the side wall of the lower pipe section 311 in a penetrating manner. External airflow can enter the atomization cavity 410 through the ventilation hole 3210, the at least one air inlet 3211, the airflow channel 3112, and the at least one air vent 3111 in sequence. Further, at least two air inlets 3211 are provided, which are distributed in a uniformly spaced manner in the circumferential direction of the first columnar portion 321, and/or at least two air vents 3111 are provided, which are distributed in a uniformly spaced manner in the circumferential direction of the lower pipe section 311. The air inlets 3211 and the air vents 3111 are communicated through the annular airflow channel 3112, so that there is no need to consider an assembling direction during the assembling of the heating base 31 and the first electrode 32. Certainly, in some other embodiments, the air inlet 3211 and the air vent 3111 may alternatively be directly communicated.

The second electrode 33 is electrically connected to the second electrode portion 4123 of the heating member 412, and may be an electrode connection sheet. The second electrode 33 may include a first connection portion 331 arranged in a vertical direction and a second connection portion 332 extending in a transverse direction from the upper end of the electrode connection portion 331. A clamping slot 3126 for mounting the first connection portion 331 is provided in the outer wall surface of the main pipe section 312. The first connection portion 331 is mounted in the clamping slot 3126 and is in contact with the inner wall surface of the main body portion 112 of the base 11 for switching on. The upper end of the clamping slot 3126 is communicated to the atomization cavity 410, so that the second connection portion 332 can be threaded from the upper end of the clamping slot 3126 into the atomization cavity 410 and resist against the second electrode portion 4123 for switching on.

The first connection portion 331 may be in a shape of a circular arc sheet, making it easy to match the main pipe section 312. The outer wall surface of the first connection portion 331 may further protrude out to form a first contact point 3311. The first connection portion 331 is in contact with the inner wall surface of the main body portion 112 through the first contact point 3311 for switching on, thereby improving the reliability of electrical connection. The second connection portion 332 may be a flat sheet and parallel to the atomization surface 4112, which is convenient for resisting against the second electrode portion 4123 for switching on. The second connection portion 332 may alternatively protrude out to form a second contact point 3321. The second connection portion 332 is in contact with the second electrode portion 4123 through the second contact point 3321 for switching on, to improve the reliability of electrical connection.

Certainly, in some other embodiments, the specific structures of both the first electrode 32 and the second electrode 33 can be transformed as needed. For example, both the first electrode 32 and the second electrode 33 may be electrode connection sheets, or the first electrode 32 and/or the second electrode 33 may include electrode columns and electrode connection sheets.

In some embodiments, the air inlet channel 31a may include a main air inlet path 319a arranged on the outer wall surface of the heating base 31 and an air outlet 310a provided in the side wall of the heating base 31 in a penetrating manner. After the heating base 31 is assembled with the base 11, the air inlet channel 31a is covered by the inner wall surface of the base 11 to form a complete air inlet path. The air inlet channel 31 is wrapped in the base 11, thereby ensuring the air tightness of the air inlet channel 31. To improve the air tightness of the air inlet channel 31a, an interference fit mode can be used for tight connection between the heating base 31 and the base 11. It can be understood that in other embodiments, the air inlet channel 31a may alternatively be arranged on the inner wall surface of the base 11, or may be simultaneously arranged on the outer wall surface of the heating base 31 and the inner wall surface of the base 11, or may be formed by a fitting gap between the base 11 and the heating base 31.

The air inlet channel 31a and the liquid down-flow channel 431 are staggered. Preferably, the air inlet channel 31a and the liquid down-flow channel 431 are respectively located on two opposite radial sides of the heating base 31. In some embodiments, the air inlet channel 31a may include a first air inlet section 311a and a second air inlet section 312a which are communicated to the atomization cavity 410 in sequence. The first air inlet section 311a may be arranged on the outer wall surface of the first branch portion 3128, and the second air inlet section 312a may be arranged on the outer wall surface of the lower pipe section 311. Both the first air inlet section 311a and the second air inlet section 312a may be in a straight line shape extending in the vertical direction. The lower end of the second air inlet section 312a is communicated to the air vent 3111, and the upper end is connected to the lower end of the first air inlet section 311a. Certainly, in some other embodiments, the first air inlet section 311a and/or the second air inlet section 312a may alternatively be in other non-straight line shapes such as an S shape, an arc shape, or a broken line shape. Or, the first air inlet section 311a and/or the second air inlet section 312a may alternatively be in a straight line shape having an angle relative to the vertical direction.

In some embodiments, the air inlet channel 31a may further include a third air inlet section 313a for communicating the air inlet hole 1110 with the second air inlet section 312a. The third air inlet section 313a may be in a circular ring shape and may be arranged on the outer wall surface of the lower pipe section 311. Due to the annular third air inlet section 313a, there is no need to consider an assembling direction during the assembling between the heating base 31 and the base 11, so that the air inlet hole 1110 and the second air inlet section 312a may be staggered in the circumferential direction, for example, in an angle of 90°. Certainly, in some other embodiments, the air inlet hole 1110 and the second air inlet section 312a may alternatively be arranged correspondingly in the circumferential direction, and the lower end of the second air inlet section 312a is directly correspondingly communicated to the air inlet hole 1110, so the annular third air inlet section 313a does not need to be provided.

When a user inhales at the inhalation opening 151, external air enters the atomization cavity 410 through the ventilation hole 3210, the air inlet 3211, the airflow channel 3112, the air vent 3111, the second air inlet section 312a, and the first air inlet section 311a in sequence. Meanwhile, the air inlet hole 1110 supplements air, and the external air enters the atomization cavity 410 through the air inlet hole 1110, the third air inlet section 313a, the second air inlet section 312a, and the first air inlet section 311a in sequence, to bring away an aerosol in the atomization cavity 410 through the aerosol outlet channel 135.

Further, in some embodiments, a chamfer 314a (including a rounded corner or a bevel corner) may alternatively be arranged in the air inlet channel 31a. For example, the chamfer 314a is arranged at a connection of the first air inlet section 311a and the second air inlet section 312a, to ensure that the air inlet channel 31a is unblocked as much as possible and the airflow flows more smoothly.

The end (i.e. the upper end of the first air inlet section 311a) of the air inlet channel 31a communicated to the atomization cavity 410 has the air outlet 310a. The air outlet 310a and the atomization surface 4112 may be respectively located on the two transversely opposite sides of the atomization cavity 410. The air outlet 310a is arranged in the side wall of the first branch portion 3128 and is higher than the bottom wall 3121, or the position of the air outlet 310a is higher than the liquid collection slot 4101, which can reduce the liquid leakage of the aerosol-forming material in the liquid collection slot 4101 from the air outlet 310a, and further avoid the airflow entering from the air outlet 310a during the inhalation from bringing the aerosol-forming material in the liquid collection slot 4101 into the inhalation channel 150.

The air outlet 310a should not be mounted at an extremely high position, otherwise, it is not conducive to fully removing an aerosol generated on the atomization surface 4112. Certainly, the air outlet 310a should not be mounted at an extremely low position, otherwise, it may cause liquid leakage. Preferably, the bottom edge of the air outlet 310a is approximately located on the same horizontal plane as the bottom edge of the heating trajectory 4122. Specifically, the bottom edge of the air outlet 310a may be located on the same horizontal plane as the bottom edge of the heating trajectory 4122, or slightly lower or higher than the bottom edge of the heating trajectory 4122. In addition, the bottom edge of the air outlet 310a may be higher or not lower than the upper end surface of the electrode column to avoid resistance from the electrode column to the flowing of the airflow at the air outlet 310a.

Further, in some embodiments, the wall surface of the atomization cavity 410 may alternatively protrude inwards to form a surrounding rib 3101 that surrounds the air outlet 310a. The inner wall surface of the surrounding rib 3101 defines an air outlet section 318a, which can further reduce the liquid leakage of the aerosol-forming material in the liquid collection slot 4101 from the air outlet 310a when the atomizer 100 is placed obliquely or horizontally. Specifically, the surrounding rib 3101 can be formed by integrally extending from the inner wall surface of the first branch portion 3128 of the heating base 31 into the atomization cavity 410. The axial direction of the surrounding rib 3101 may be perpendicular to the atomization surface 4112. Certainly, in other embodiments, the axial direction of the surrounding rib 3101 may alternatively be slantways arranged in an angle with the atomization surface 4112. In this embodiment, the air outlet 310a is a round hole. the surrounding rib 3101 is in a circular tube shape and has a hole diameter consistent with that of the air outlet 310a. The surrounding rib 3101 may be formed by integrally inwards extending from the peripheral edge of the air outlet 310a, making the airflow flow more smoothly. Certainly, in some other embodiments, the cross section of the air outlet 310a and the cross section of the surrounding rib 3101 can alternatively be elliptical, square, or in other shapes. In addition, the cross-sectional area of the surrounding rib 3101 may alternatively be larger or smaller than that of the air outlet 310a. Certainly, in some other embodiments, the heating base 31 may not have the surrounding rib 3101 formed thereon.

The cross-sectional area of the air outlet 310a is smaller than that of another position on the air inlet channel 31a. Namely, the air outlet 310a has the smallest cross-sectional area in the entire air inlet channel 31a. On the one hand, the airflow in the air inlet channel 31a can be accelerated to enter the atomization cavity 410 through the air outlet 310a, which is conducive to fully removing the aerosol-forming material in the atomization cavity 410, and on the other hand, it is conducive to reducing the liquid leakage. In some embodiments, the cross-sectional area of the air outlet 310a may be between 0.5 mm² and 3 mm². The cross-sectional area of the another position in the air inlet channel 31a should be as large as possible to ensure sufficient air feeding.

In some embodiments, the vent channel 31b may be arranged on the outer wall surface of the heating base 31, and an outlet 313b of the vent channel 31b may be communicated to the liquid storage cavity 120, and an inlet 310b of the vent channel 31b may be communicated to the atomization cavity 410. Preferably, the inlet 310b is communicated to the liquid collection slot 4101, so that the aerosol-forming material in the liquid collection slot 4101 is partially sucked back into the liquid storage cavity 120. To ensure smooth ventilation, the cross-sectional area of the inlet 310b is smaller than or equal to the cross-sectional area of the outlet 313b. Preferably, the cross-sectional area of the inlet 310b is the smallest in the cross-sectional area of the entire vent channel 31b. The bottom edge of the inlet 310b is higher than the bottom wall surface of the liquid collection slot 4101, or the liquid collection slot 4101 is arranged below the vent channel 31b to avoid liquid leakage.

The vent channel 31b is staggered from the air inlet channel 31a and the liquid down-flow channel 431. Preferably, the vent channel 31b is arranged on the side opposite to the liquid down-flow channel 431. The shape of the vent channel 31b is not limited and may be in various shapes such as a straight line shape, an arc shape, and an S shape. The specific shape and size (including the length and the cross-sectional area) of the vent channel 31b may be adjusted according to a ventilation situation. Preferably, the vent channel 31b is a capillary channel, which is conducive to storing a number of aerosol-forming materials through a capillary force and can suck back the aerosol-forming material in the liquid collection slot 4101 through the capillary force.

Specifically, the vent channel 31b may include a first vent section 311b arranged on the outer wall surface of the first branch portion 3128 and a second vent section 312b arranged on the outer wall surface of the second branch portion 3129. After the heating base 31 is assembled with the liquid storage shell 12 and the base 11, the first vent section 311b is covered by the inner wall surface of the base 11, and the second branch portion 3129 is covered by the inner wall surface of the liquid storage shell 12, thus forming a complete vent path. It can be understood that in other embodiments, the vent channel 31b may alternatively be arranged at the liquid storage shell 12 or the base 11, or may be formed by a fitting gap between the heating base 31 and the liquid storage shell 12 or the base 11.

The inlet 310b of the vent channel 31b is staggered from the air outlet 310a of the air inlet channel 31a, and the cross-sectional area of the inlet 310b is smaller than or equal to the cross-sectional area of the air outlet 310a. The separate design of the vent channel 31b, the air inlet channel 31a, and the liquid collection slot 4101 can effectively avoid the problem of blockage caused by the liquid leakage. Preferably, the bottom edge of the inlet 310b is lower than the bottom edge of the air outlet 310a. Still further, the top edge of the inlet 310b is lower than the bottom edge of the air outlet 310a, which can prevent the aerosol-forming material in the liquid collection slot 4101 from flowing to the air outlet 310a, so that the problem of blockage caused by the liquid leakage can be effectively avoided.

When the atomizer 100 is in operation, the external air enters the atomization cavity 410 and the liquid collection slot 4101 through the air inlet channel 31a. During the inhalation, a negative pressure may be generated in the liquid storage cavity 120 as the aerosol-forming material is consumed. When the negative pressure reaches a threshold (a vent threshold can be matched and adjusted by adjusting the cross-sectional area and length of the vent channel 31b), air may enter the vent channel 31b from the inlet 310b in the lower end under the action of an atmospheric pressure, and then enter the liquid storage cavity 120 via the outlet 313b in the upper end for ventilation. In another aspect, when the liquid storage cavity 120 has a large space, if there is a large temperature difference during placement, the air in the cavity may push the aerosol-forming material into the vent channel 31b. The vent channel 31b has a length to store this part of aerosol-forming material. The inlet 310b in the lower end of the vent channel 31b is communicated to the liquid collection slot 4101, which can guide the aerosol-forming material, remaining after the vent channel 31b is fully filled, into the liquid collection slot 4101, to prevent the liquid leakage. When there are many aerosol-forming materials in the liquid collection slot 4101, the aerosol-forming materials may alternatively be sucked back into the liquid storage cavity 120.

The atomizer 100 may be assembled in a modularized manner, and assembling steps may be as follows: (1) First, the seal gasket 42 sleeves the heating element 41. Then, the heating element 41 and the seal gasket 42 are mounted onto the fixing base 43 through interference fit to form the atomization assembly 40. (2) The first electrode 32 and the second electrode 33 are assembled onto the heating base 31 to form the atomization base assembly 30. The first electrode 32 and the second electrode 33 are respectively in contact with the first electrode portion 4121 and the second electrode portion 4123 of the heating member 412, and have a pre-tightening pressure. (3) The atomization assembly 40 is vertically pressed onto the atomization base assembly 30 from the side surface by interference fit, thereby forming the atomization main body 20. (4) Finally, the atomization main body 20, the aerosol guide pipe 13, and the base 11 are assembled and are pushed into the liquid storage shell 12. The seal element 14 and the mouthpiece 15 are mounted after liquid injection.

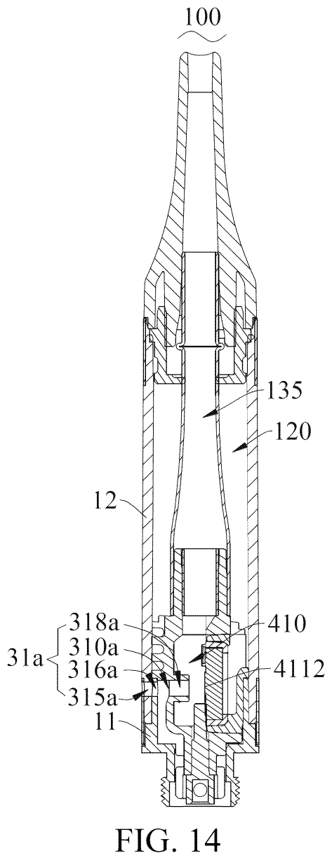

FIG. 14 shows an air inlet channel 31a in some other embodiments. In this embodiment, the entire air inlet channel 31a is a straight channel extending in a transverse direction, and an axial direction of the air inlet channel 31a may be perpendicular to the atomization surface 4112.

Specifically, the air inlet channel 31a includes an air inlet hole 315a that is provided in the side wall of the liquid storage shell 12 in a penetrating manner, an air inlet hole 316a that is provided in the side wall of the base 11 in a penetrating manner, an air outlet 310a that is provided in the side wall of the heating base 31 in a penetrating manner, and an air outlet section 318a that extends from the air outlet 310a into the atomization cavity 410. Certainly, in some other embodiments, the air outlet 310a can alternatively be arranged at a portion of the heating base 31 extending out of the base 11. In this case, the air inlet 316a does not need to be provided in the base 11.

It can be understood that the foregoing technical features can be used in any combination without limitation.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An atomizer, comprising:
a liquid storage main body, a liquid storage cavity and an aerosol outlet channel being formed in the liquid storage main body;
a heating base arranged in the liquid storage main body in an axial direction; and
an atomization assembly mounted at the heating base, an atomization cavity communicated to the aerosol outlet channel being formed between the atomization assembly and the heating base, the atomization assembly comprising an atomization surface communicated to the aerosol outlet channel in an aerosol guiding manner,
wherein the atomization surface and a longitudinal axis of the atomizer are parallel to each other or form an acute angle,
wherein an air inlet channel for communicating the atomization cavity to external atmosphere is formed on the liquid storage main body and/or the heating base, and
wherein the air inlet channel is at least partially orthogonal to or forms an angle with the atomization surface.

2. The atomizer of claim 1, wherein the air inlet channel includes a main air inlet path arranged on an outer surface of the heating base and an air outlet provided in a side wall of the heating base in a penetrating manner, and
wherein an axis of the air outlet is orthogonal to or forms an acute angle with the atomization surface.

3. The atomizer of claim 1, wherein the air inlet channel includes an air inlet hole provided in a side wall of the liquid storage main body in a penetrating manner and an air outlet provided in a side wall of the heating base in a penetrating manner, and
wherein an axis of the entire air inlet channel is orthogonal to or forms an acute angle with the atomization surface.

4. The atomizer of claim 1, wherein the air inlet channel is provided with an air outlet in an end communicated to the atomization cavity,
wherein the air outlet is provided in a side wall of the heating base in a penetrating manner, and
wherein the air outlet and the atomization surface are respectively located on two opposite sides of the atomization cavity.

5. The atomizer of claim 4, wherein the an wall surface of the heating base inwards protrudes to form a surrounding rib that surrounds the air outlet.

6. The atomizer of claim 5, wherein an axial direction of the surrounding rib is perpendicular to the atomization surface or forms an acute angle with the atomization surface.

7. The atomizer of claim 1, wherein the heating base comprises a main pipe section and a lower pipe section downwardly extending from a lower end surface of the main pipe section,
wherein a cavity provided with an opening in a circumferential side is formed in the main pipe section, the atomization assembly being embedded into an opening of the cavity,
wherein the air inlet channel includes a first air inlet section arranged on an outer wall surface of the main pipe section and a second air inlet section arranged on an outer wall surface of the lower pipe section, and
wherein a chamfer is formed at a connection of the first air inlet section and the second air inlet section.

8. The atomizer of claim 1, wherein the atomization assembly comprises a heating element and a fixing base,
wherein the heating element is embedded into one side of the fixing base,
wherein a liquid down-flow channel for communicating the liquid storage cavity to the heating element is formed in the fixing base, and
wherein the air inlet channel and the liquid down-flow channel are respectively located on two opposite sides of the heating element.

9. The atomizer of claim 8, wherein the heating element is plate-like.

10. An electronic atomization device, comprising:
the atomizer of claim 1; and
a power supply device connected to the atomizer in a matched manner.
